(19) United States
(12) Patent Application Publication
(10) Pub. No.: US 2008/0021165 A1
(43) Pub. Date: Jan. 24, 2008

(54) Fibres Having Elastic Properties

(76) Inventors: Franco Sartori, Ferrara (IT); Paolo Goberti, Vigarano Mainarda (Ferrara) (IT); Fabio Di Pietro, Ferrara (IT)

Correspondence Address: BASELL USA INC., INTELLECTUAL PROPERTY, 912 APPLETON ROAD, ELKTON, MD, 21921, US

(21) Appl. No.: 11/794,040

(22) PCT Filed: Dec. 22, 2005
(86) PCT No.: PCT/EP05/57097

§ 371 Date: Jun. 22, 2007

Related U.S. Application Data
(60) Provisional application No. 60/663,927, filed on Mar. 21, 2005.

(30) Foreign Application Priority Data
Dec. 23, 2004 (EP) 04030608.6

(51) Int. Cl. C08L 23/06

(52) U.S. Cl. 525/240

(57) ABSTRACT

Fibres exhibiting good elastic properties and made from a thermoplastic, elastomeric polyolefin composition comprising (percent by weight): (A) 10 to less than 50% of one or more crystalline propylene polymers selected from homopolymers of propylene and random interpolymers of propylene and one or more recurring units in amounts up to 10%, the recurring units being selected from ethylene and a C₄-C₁₀ α-olefin, the polymer(s) being insoluble in xylene at room temperature in an amount higher than 80%; and (B) over 50 to 90% of a polymer fraction comprising one or more interpolymers of ethylene and at least one α-olefin of formula H₂C═CHR₂, where R₂ is a C₁-C₈ linear or branched alkyl, containing from 13 to less than 60% of recurring units deriving from ethylene. The fibres are prepared by a process operating at a value of output per hole ranging from 5 to 15 g/min, the pressure in the extruder ranging from 15 to 30 bar, the temperature in the extruder head ranging from 200 to 300° C.

The present invention relates to polyolefin fibres and articles made from such fibres. In particular, the invention relates to elastic polyolefin fibres and elastic articles, such as fabrics and ropes, obtained from said fibres, and a process for the production of said fibres. More particularly, the present invention concerns propylene polymer fibres which can be produced with good spinnability and exhibit elastic properties.

The definition of fibres includes monofilaments and cut fibres (staple fibres).

Elastic fibres are already known and are prepared from polyurethane. The shortcoming of such fibres is their high cost. Hence, there is a need for cheaper elastic fibres.

It is known that polypropylene exhibits quite good spinnability properties. On the other hand, elastomeric ethylene-propylene copolymer alone has almost no spinnability but it has higher elastic properties than crystalline polypropylene and is good in the compatibility with crystalline propylene polymers.

Fibres obtainable by spinning thermoplastic, elastomeric polyolefin compositions comprising a crystalline polypropylene and elastomeric polyolefin are already mentioned in the patent literature, for example in European patent application 391 438. However, no concrete example of fibres made from a composition comprising an elastomeric polymer is reported in such literature.

U.S. Pat. No. 4,211,819 discloses heat-melt adhesive propylene polymer fibres made from a two-component resin wherein an ethylene-propylene copolymer rubber is blended with a crystalline propylene-butene-1-ethylene terpolymer. The terpolymer, which is good in compatibility with the rubber, gives spinnability to the rubber that makes the fibre adhesive. The amount of rubber in the resin is at most 50 wt % and the ethylene content in the rubber is higher than 70 wt % in the examples, so that the fibre is relatively low elastic.

European patent applications No 552 810, 632 147 and 632 148 also disclose fibres made from polymer blends comprising elastomeric polyolefins and/or very low crystalline polyolefins. However, the fibres are made from polymer compositions rich in crystalline propylene polymer and contain elastomeric propylene-ethylene copolymers and/or highly modified propylene copolymer only in amounts of at most 30 wt % in the examples.

Now it has surprisingly been found that fibres having good elastic properties, in particular low residual deformation after elastic recovery, can be obtained by spinning specific thermoplastic, elastomeric polyolefin compositions.

The main advantage of the present invention is that the increase in the elastic properties is not to the detriment of the tenacity of the fibre.

Another advantage of the fibres is from an economic viewpoint. Highly elastic fibres can now be obtained by using polyolefins, which are low-cost materials.

An additional advantage of the present invention is that the achievement of such properties is not to the detriment of the productivity and industrial feasibility of the process.

Therefore the present invention provides fibres made from a thermoplastic, elastomeric polyolefin composition (I) comprising (percent by weight):
(A) 10 to less than 50%, preferably 13 to 40%, of one or more crystalline propylene polymers selected from homopolymers of propylene and random interpolymers of propylene and one or more recurring units in amounts up to 10%, the recurring units being selected from ethylene and C₄-C₁₀ α-olefins, the said propylene polymer(s) being insoluble in xylene at room temperature in an amount higher than 80%, preferably 90%; and
(B) over 50 to 90%, preferably 60 to 87%, of a polymer fraction comprising one or more interpolymers of ethylene and at least one α-olefin of formula H₂C═CHR₂, where R₂ is a C₁-C₈ linear or branched alkyl, said interpolymer(s) containing from 13 to less than 60%, in particular from 13% to 55%, of recurring units deriving from ethylene.

In the present disclosure room temperature refers to a temperature of about 25° C.

The term “interpolymer” as used herein refers to polymers prepared by the polymerization of at least two different types of monomers. The generic term “interpolymer” thus includes the term “copolymers” (which is usually employed to refer to polymers prepared from two different monomers) as well as the term “terpolymers” (which is usually employed to refer to polymers prepared from three different types of monomers, e.g., an ethylene/butene/propylene polymer).

The propylene polymer(s) (A) typically exhibit a stereoregularity of the isotactic type.

Moreover, the fibres according to the present invention typically exhibit a value of residual deformation after elastic recovery lower than 20%.

The fibres according to the present invention also exhibit good values of elongation at break. As known some properties of fibres are strongly dependent on the process conditions and one of them is the value of elongation at break that in particular depends on the take up speed and also hole output. To exemplify, the fibres according to the present invention typically exhibit a value of elongation at break higher than 800% when the process has a value of take up speed of at most 250 m/min. It is well-known that when the take up speed increases, the value of the elongation at break of the fibre decreases. For example, when the take up speed is at least 500 g/min, the elongation at break is less than 500%.

The fibres according to the present invention typically possess a value of tenacity higher than 5 cN/tex with standard throughput.

Particularly preferred, according to the present invention, are the fibres having a relatively large diameter, in particular equal to or greater than 25 μm, more preferably equal to or greater than 50 μm, for example from 25 or from 50 to 700 μm. These fibres are generally in the form of monofilament.

The polyolefin composition used to prepare the fibres according to the present invention typically has a value of melt flow rate (MFR) from 0.3 to 25, preferably 0.3 to 20, g/10 min. The said values are obtained directly in polymerisation or through controlled chemical degradation of the polymer composition in the presence of a radical initiator, such as an organic peroxide, 2,5-bis(tert-butylperoxy)-2,5-dimethylhexane for example, which is added during the granulation phase or directly in the extrusion phase of the fibres. The chemical degradation is carried out according to well-known methods.

The propylene polymer(s) (A) are selected from propylene homopolymers or random polymers of propylene with an a-olefin selected from ethylene and a linear or branched C₄-C₈ α-olefin, such as copolymers and terpolymers of propylene. The said component (A) can also comprise mixtures of the said polymers, in which case the mixing ratios are not critical. Preferably, the α-olefin is represented by the formula CH₂═CHR, wherein R is an alkyl radical, linear or branched, with 2-8 carbon atoms, selected in particular from the class consisting of ethylene, 1-butene, 1-pentene, 1-hexene, 1-heptene, 1-octene, 1-nonene, 1-decene and 4-methyl-1-pentene.

The polymer fraction (B) is partially soluble in xylene at room temperature. Typically, the interpolymers are over 70% soluble. The xylene-insoluble polymer fraction is an ethylene-interpolymer having an ethylene content of at least 50%. Typically, the xylene-insoluble interpolymer has an ethylene-type crystallinity.

The polymer fraction (B) can optionally contain a recurring unit deriving from a diene in amounts from 0.5 to 5 wt % with respect to the weight of such fraction (B). The diene can be conjugated or not and is selected from butadiene, 1,4-hexadiene, 1,5-hexadiene, and ethylidene-norbornene-1, for example.

In a particular embodiment of the present invention, the fibres are made from the above-composition (I) in which the polymer fraction (B) comprises two different interpolymers. A particular example of the mentioned polymer composition is a polyolefin composition (II) comprising (per cent by weight):
(A) 10-25% of a crystalline propylene polymer selected from propylene homopolymer and an interpolymer of propylene and at least one α-olefin of formula H₂C═CHR₂, where R₂ is hydrogen or a C₂-C₈ linear or branched alkyl, containing at least 90% of propylene, the polymer having a solubility in xylene at room temperature lower than 20%, and
(B) 75-90% of an elastomeric polymer fraction comprising:
   (i) a first elastomeric interpolymer of propylene and at least one α-olefin of formula H₂C═CHR₂, where R₂ is hydrogen or a C₂-C₈ linear or branched alkyl, optionally containing 0.5 to 5% of a diene, said first elastomeric interpolymer containing from 15 to 32% of the α-olefin and having solubility in xylene at room temperature greater than 50%, the intrinsic viscosity of the xylene-soluble fraction ranging from 1.0 to 5.0, preferably 1.5 to 5 dl/g; and
   (ii) a second elastomeric interpolymer of propylene and at least one α-olefin of formula H₂C═CHR₂, where R₂ is hydrogen or a C₂-C₈ linear or branched alkyl, optionally containing 0.5 to 5% of a diene, said second elastomeric interpolymer containing more than 32 up to 45% of the α-olefin and having solubility in xylene at room temperature greater than 80%, the intrinsic viscosity of the xylene-soluble fraction ranging from 4.0 to 6.5, preferably 2 to 6 dl/g The weight ratio between (i) and (ii) typically ranges from 1:5 to 5:1.

The above compositions are already known; for example they are disclosed in the international patent application WO 03/1169.

Said composition (I) and composition (II) are prepared by a process comprising at least two and three sequential polymerization stages respectively, with each subsequent polymerization stage being conducted in the presence of the polymeric material formed in the immediately preceding polymerization reaction, wherein the crystalline polymer (A) is prepared in at least one stage, and the elastomeric fraction (B) is prepared in at least one or two sequential stages. The polymerization stages may be carried out in the presence of a Ziegler-Natta and/or a metallocene catalyst. Suitable Ziegler-Natta catalysts are described in U.S. Pat. No. 4,399,054 and EP-A-45 977. Other examples are disclosed in U.S. Pat. No. 4,472,524.

The solid catalyst components used in said catalysts comprise, as electron-donors (internal donors), compounds selected from the group consisting of ethers, ketones, lactones, compounds containing N, P and/or S atoms, and esters of mono- and dicarboxylic acids. Particularly suitable electron-donor compounds are phthalic acid esters, such as diisobutyl,dioctyl, diphenyl and benzylbutyl phthalate.

Other suitable electron-donors are 1,3-diethers of formula: 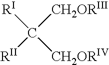
wherein R¹ and R^{II}, the same or different from each other, are C₁-C₁₈ alkyl, C₃-C₁₈ cycloalkyl or C₇-C₁₈ aryl radicals; R^{III} and R^{IV}, the same or different from each other, are C₁-C₄ alkyl radicals; or are the 1,3-diethers in which the carbon atom in position 2 belongs to a cyclic or polycyclic structure made up of 5, 6 or 7 carbon atoms and containing two or three unsaturations.

Ethers of this type are described in EP-A-361 493 and EP-A-728 769.

Representative examples of said dieters are 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane, and 9,9-bis(methoxymethyl)fluorene.

The preparation of the above mentioned catalyst components is carried out according to various methods. For example, an MgCl₂.nROH adduct (in particular in the form of spheroidal particles) wherein n is generally from 1 to 3 and ROH is ethanol, butanol or isobutanol, is reacted with an excess of TiCl₄ containing the electron-donor compound. The reaction temperature is generally from 80 to 120° C. The solid is then isolated and reacted once more with TiCl₄, in the presence or absence of the electron-donor compound, after which it is separated and washed with aliquots of a hydrocarbon until all chlorine ions have disappeared. In the solid catalyst component the titanium compound, expressed as Ti, is generally present in an amount from 0.5 to 10% by weight. The quantity of electron-donor compound which remains fixed on the solid catalyst component generally is 5 to 20% by moles with respect to the magnesium dihalide.

The titanium compounds which can be used in the preparation of the solid catalyst component are the halides and the halogen alcoholates of titanium. Titanium tetrachloride is the preferred compound.

The reactions described above result in the formation of a magnesium halide in active form.

Other reactions are known in the literature, which cause the formation of magnesium halide in active form starting from magnesium compounds other than halides, such as magnesium carboxylates.

The Al-alkyl compounds used as co-catalysts comprise Al-trialkyls, such as Al-triethyl, Altriisobutyl, Al-tri-n-butyl, and linear or cyclic Al-alkyl compounds containing two or more Al atoms bonded to each other by way of O or N atoms, SO₄ or SO₃ groups. The Al-alkyl compound is generally used in such a quantity that the Al/Ti ratio be from 1 to 1000.

The electron-donor compounds that can be used as external donors include aromatic acid esters such as alkyl benzoates, and in particular silicon compounds containing at least one Si—OR bond, where R is a hydrocarbon radical.

Examples of silicon compounds are (tert-butyl)₂Si(OCH₃)₂, (cyclohexyl)(methyl)Si(OCH₃)₂, (phenyl)₂Si(OCH₃)₂ and (cyclopentyl)₂Si(OCH₃)₂. 1,3-diethers having the formulae described above can also be used advantageously. If the internal donor is one of these dieters, the external donors can be omitted.

The solid catalyst component have preferably a surface area (measured by BET) of less than 200 m²/g, and more preferably ranging from 80 to 170 m²/g, and a porosity (measured by BET) preferably greater than 0.2 ml/g, and more preferably from 0.25 to 0.5 ml/g.

The catalysts may be precontacted with small quantities of olefin (prepolymerization), maintaining the catalyst in suspension in a hydrocarbon solvent, and polymerizing at temperatures from ambient to 60° C., thus producing a quantity of polymer from 0.5 to 3 times the weight of the catalyst. The operation can also take place in liquid monomer, producing, in this case, a quantity of polymer 1000 times the weight of the catalyst.

The polymerization process of the composition comprises at least two stages, all carried out in the presence of Ziegler-Natta catalysts, where: in the first stage the relevant monomer(s) are polymerized to form the crystalline polymer (A); in the second stage a mixture of ethylene and an α-olefin H₂C═CHR₂, where R₂ is a C₁-C₈ alkyl, and optionally a diene are polymerized to form interpolymer (B)(i); and in the third stage a mixture of ethylene and an α-olefin H₂C═CHR₂, where R₂ is a C₁-C₈ alkyl, and optionally a diene, are polymerized to form the interpolymer (B)(ii), when required.

The polymerization stages may occur in liquid phase, in gas phase or liquid-gas phase.

Preferably, the polymerization of the crystalline polymer fraction (A) is carried out in liquid monomer (e.g. using liquid propylene as diluent), while the copolymerization stages for the preparation of the interpolymers (B)(i) and (B)(ii) are carried out in gas phase, without intermediate stages except for the partial degassing of the propylene. According to a most preferred embodiment, all the sequential polymerization stages are carried out in gas phase.

The reaction temperature in the polymerization stage for the preparation of the crystalline polymer (A) and in the preparation of interpolymers (B)(i) and (B)(ii) can be the same or different, and is preferably from 40° C. to 90° C.; more preferably, the reaction temperature ranges from 50 to 80° C. in the preparation of the fraction (A), and from 40 to 80° C. for the preparation of interpolymers (B)(i) and (B)(ii).

The pressure of the polymerization stage to prepare the fraction (A), if carried out in liquid monomer, is the one which competes with the vapor pressure of the liquid propylene at the operating temperature used, and is possibly modified by the vapor pressure of the small quantity of inert diluent used to feed the catalyst mixture, and the overpressure of the monomers and the hydrogen optionally used as molecular weight regulator.

The polymerization pressure preferably ranges from 33 to 43 bar, if done in liquid phase, and from 5 to 30 bar if done in gas phase. The residence times relative to the three stages depend on the desired ratio between the fractions, and can usually range from 15 minutes to 8 hours.

Conventional molecular weight regulators known in the art, such as chain transfer agents (e.g. hydrogen or ZnEt₂), may be used.

The above thermoplastic, elastomeric, polyolefin composition can also comprise further polymers in addition to the set forth polymers. Such polymers can be selected from polyethylene, in particular very low density polyethylene, and are preferably in amounts up to 10 wt % on the whole polymer composition.

Another embodiment of the present invention is a spinning process for the production of the invented fibres.

The fibres according to the present invention can be obtained by spinning the above-mentioned thermoplastic, elastomeric, polyolefin composition at following operating conditions:
value of output per hole ranging from 5 to 15 g/min, preferably 7.5 to 12 g/min.
pressure in the extruder ranging from 10 to 40 bar, preferably from 10 to 30 bar, and
temperature in the extruder head ranging from 200 to 300° C.

The spinning process is carried out at a broad range of value of take-up speed of the fibre, for example such speed can range from 200 to 1000 m/min.

Preferably, the temperature in the extruder is lower the higher is the value of MFR of the polymer composition. Typically, the temperature ranges from 270 to 300° C. for compositions having a MFR value ranging from 0.3 to 1.5 g/10 min, from 250 to 270° C. for compositions having a MFR value ranging from 1.5 to 5 g/10 min and from 230 to 250° C. for compositions having a MFR value ranging from 5 to 25 g/10 min.

The fibre thus produced can optionally be subject to further drawing stage to increase the tenacity.

The polyolefin composition used for fibres and non-woven fabrics of the present invention can also contain additives commonly employed in the art, such as antioxidants, light stabilizers, heat stabilizers, antistatic agents, flame retardants, fillers, nucleating agents, pigments, anti-soiling agents, photosensitizers.

As discussed above, another embodiment of the present invention is represented by articles, such as non-woven fabrics, ropes, including the fibres according to the present invention.

The following examples are given to illustrate and not to limit the present invention.

The data relating to the polymeric materials and the fibres of the description and examples are determined by way of the methods reported below.
Melt Flow Rate (MFR): ISO method 1133 (230° C., 2.16 kg).
Ethylene content: by IR spectroscopy.
Fractions soluble and insoluble in xylene at 25° C.: 2.5 g of polymer are dissolved in 250 ml of xylene at 135° C. under agitation. After 20 minutes the solution is allowed to cool to 25° C., still under agitation, and then allowed to settle for 30 minutes. The precipitate is filtered with filter paper, the solution evaporated in nitrogen flow, and the residue dried under vacuum at 80° C. until constant weight is reached. Thus one calculates the percent by weight of polymer soluble and insoluble at room temperature.
Titre of filaments: from a 10 cm long roving, 50 fibres are randomly chosen and weighed. The total weight of the said 50 fibres, expressed in mg, is multiplied by 2, thereby obtaining the titre in dtex.
Tenacity and Elongation (at break) of filaments: from a 500 m roving a 100 mm long segment is cut. From this segment the single fibres to be tested are randomly chosen. Each single fibre to be tested is fixed to the clamps of an Instron dinamometer (model 1122) and tensioned to break with a traction speed of 20 mm/min for elongations lower than 100% and 50 mm/min for elongations greater than 100%, the initial distance between the clamps being of 20 mm. The ultimate strength (load at break) and the elongation at break are determined.

The tenacity is derived using the following equation:
Tenacity=Ultimate strength (cN)×10/Titre (dtex).
Residual deformation after elastic recovery: According to method ASTM-D 1744-64 with 10% of deformation applied.

### EXAMPLES 1-3

A thermoplastic, elastomeric, polyolefin composition having a value of MFR of 2.5 g/10 min was used, comprising (parts and per cent by weight):
(A) 29% of a crystalline random copolymer of propylene and 3.5% ethylene; the copolymer containing less than 8% of a polymer fraction soluble in xylene at room temperature and having a melt flow rate value of 75 g/10 min; and
(B) 71% of an elastomeric propylene-ethylene copolymer fraction having a total ethylene content of about 16.1%, solubility in xylene at room temperature of about 58% and value of intrinsic viscosity [η] of 2.25 dl/g.

The composition was obtained by sequential polymerisation in presence of a high yield, high stereospecific Ziegler-Natta catalyst supported on magnesium dichloride, containing diisobutylphtahalate as internal electron-donor compound and dicyclopenthyldimethoxysilane (DCPMS) as external electron-donor compound.

The polymerization was done in stainless steel fluidized bed reactors. During the polymerization, the gas phase in each reactor was continuously analyzed by gaschromatography in order to determine the content of ethylene, propylene and hydrogen. Ethylene, propylene, 1-butene and hydrogen were fed in such a way that during the course of the polymerization their concentration in gas phase remained constant, using instruments that measure and/or regulate the flow of the monomers. The operation was continuous in three stages, each one comprising the polymerization of the monomers in gas phase. Propylene was prepolymerized in liquid propane in a 75 liters stainless steel loop reactor with an internal temperature of 20-25° C. in the presence of a catalyst system comprising a solid component (15-20 g/h) as described above, and a mixture of 75-80 g/h Al-triethyl (TEAL) in a 10% hexane solution and an appropriate quantity of DCPMS donor, so that the TEAL/DCPMS wt. ratio was 5.

1st stage—The thus obtained prepolymer was discharged into the first gas phase reactor, operated at a temperature of 60° C. and a pressure of 14 bar. Thereafter, hydrogen, propylene, ethylene and an inert gas were fed to carry out the polymerization.

2nd stage—After removing a sample to carry out the various analyses, the polymer obtained from the first stage was discharged into the second phase reactor operated at a temperature of 60° C. and a pressure of 18 bar. Thereafter, hydrogen, propylene, ethylene and an inert gas were fed, to carry out the polymerization.

The MFR value of the pellets obtained extruding the polymer composition thus obtained was 2.5 g/10 min.

The composition thus prepared was spun in a Leonard pilot plant (extruder diameter: 25 mm, compression ratio: 1:3, maximum flow: 2.35 kg/h) so as to produce a monofilament fibre. The said composition was spun at different speed as recorded in Table 1. The pressure in the extruder head was 25 bar.

The further process conditions and performance of the fibre are reported in the Table 1 hereinbelow.

### EXAMPLE 4

Example 1 was repeated except that before spinning the polymer composition was chemically degraded with the 2,5-bis(tert-butylperoxy)-2,5-dimethylhexane up to achieving a composition having the melt flow rate value of 8.5 g/10 min.

The process conditions and performance of the fibre are reported in the Table 2 hereinbelow.

### EXAMPLE 5

Example 1 was repeated except that the polymer composition was replaced with a composition having a MFR value of 9.2 g/10 min obtained by chemical degradation by means of 2,5-bis(tert-butylperoxy)-2,5-dimethylhexane of the following composition (parts and per cent by weight):
(A) 31% of a crystalline random copolymer of propylene and 3.2% ethylene; the copolymer containing less than 6.5% of a polymer fraction soluble in xylene at room temperature, having a value of intrinsic viscosity [η] of 3.2 dl/g, and a melt flow rate value of 25 g/10 min; and
(B) 69% of an elastomeric propylene-ethylene copolymer having an ethylene content of 27%, solubility in xylene at room temperature of about 56 wt %, a melt flow rate value of 1.2 g/10 min.

In the polymer composition the intrinsic viscosity of the polymer fraction soluble in xylene at ambient temperature was 3.2 dl/g.

### COMPARATIVE EXAMPLES 1 AND 2

Example 1 was repeated except that composition 1 was replaced with compositions A and B in comparative examples 1 and 2, respectively.

Polymer composition A was a crystalline isotactic propylene homopolymer having a MFR value of 3 g/10 min and a xylene-soluble content of about 4 wt %. It was produced by using a Ziegler-Natta catalyst having a phthalate as internal electron-donor compound.

Polymer composition B was a crystalline isotactic propylene homopolymer having a MFR value of 12 g/10 min and a xylene-soluble content of about 4 wt %. It was produced by using a Ziegler-Natta catalyst having a diether as internal electron-donor compound.

The further process conditions and performance of the fibre are reported in the Table 1 hereinbelow.

TABLE 1

| Comparative | Examples | | |
|---|---|---|---|
| Example 1 | 1 | 2 | 3 |

Test Conditions

| | | | | |
|---|---|---|---|---|
| Head Temperature, ° C. | 285 | 270 | 270 | 270 |
| Hole Output, g/min | 7.5 | 7.5 | 7.5 | 7.5 |
| Melt temperature. ° C. | 291 | 277 | 277 | 277 |
| Air temperature, ° C. | 13.2 | 11.5 | 11.5 | 11.5 |
| Quenching air speed, m/sec | 0.94 | 0.94 | 0.94 | 0.94 |
| Take up speed, m/min | 250 | 250 | 500 | 700 |

Properties

| | | | | |
|---|---|---|---|---|
| Titre, dtex | 301 | 283 | 156 | 106 |
| Tenacity, cN/tex | 8.4 | 11 | 16.4 | 21.1 |
| Elongation at break, % | >800 | >800 | 560 | 415 |
| Residual deformation, % | 28 | 9 | 13 | 17.5 |

TABLE 2

| | |
|---|---|
| Examples | Comparative |

| | | |
|---|---|---|
| 4 | 5 | example 2 |

Test Conditions

| | | | |
|---|---|---|---|
| Head Temperature, ° C. | 245 | 245 | 265 |
| Hole Output, g/min | 7.5 | 7.5 | 7.5 |
| Melt temperature. ° C. | 251 | 252 | 272 |
| Air temperature, ° C. | 10.8 | 11 | 14.9 |
| Take up speed, m/min | 250 | 250 | 250 |

Properties

| | | | |
|---|---|---|---|
| Titre, dtex | 300 | 308 | 330 |
| Tenacity, cN/tex | 7.1 | 5.9 | 6.1 |
| Elongation at break, % | >800 | >800 | >800 |
| Residual deformation, % | 11 | 7 | 34 |

### EXAMPLE 6

Example 1 was repeated except that the composition was replaced with the following thermoplastic, elastomeric polyolefin composition having a MFR value of 0.6 g/10 min and comprising (per cent by weight):
(A). 16.5% of a crystalline random copolymer of propylene and 3.25% ethylene; the copolymer containing less than 6.5% of a polymer fraction soluble in xylene at room temperature and having a melt flow rate value of 5.5 g/10 min; and
(B) 83.5% of an elastomeric propylene-ethylene copolymer fraction, comprising the following components:
   (i) 50.5%, with respect to the whole polymer composition, of an elastomeric propylene-ethylene copolymer having an ethylene content of 28%, solubility in xylene at room temperature of 72% and value of intrinsic viscosity [η] of 4.2 dl/g; and
   (ii) 33%, with respect to the whole polymer composition, of an elastomeric propylene-ethylene copolymer having an ethylene content of 38%.

The xylene-soluble fraction of the whole polymer composition exhibited a value of intrinsic viscosity [η] of 5.6 dl/g. and solubility in xylene at room temperature of 77%.

The elastomeric component (B) was produced in two different gas-phase reactors.

The process conditions and performance of the fibre are reported in the Table 3 hereinbelow.

### EXAMPLE 7

Example 6 was repeated except that the process was carried out at a different value of output per hole.

The process conditions and performance of the fibre are reported in the Table 3 hereinbelow.

### EXAMPLE 8

Example 6 was repeated except that the polymer composition was replaced with a thermoplastic, elastomeric polyolefin composition having an MFR value of 0.61 g/10 min and made of 94.85 parts by weight of the polymer composition used in example 4 and 5 parts by weight of a very low density polyethylene having density of less than 0.900 g/ml, an MFR value of 3 g/10 min, a 17.2 wt % butane-1 as comonomer.

The process conditions and performance of the fibre are reported in the Table 3 hereinbelow.

### EXAMPLE 9

Example 6 was repeated except that the process was carried out at different value of output per hole.

The process condition and performance of the fibre are reported in the Table 3 hereinbelow.

TABLE 3

| Examples | | | |
|---|---|---|---|
| 6 | 7 | 8 | 9 |

Test Conditions

| | | | | |
|---|---|---|---|---|
| Head Temperature, ° C. | 290 | 290 | 280 | 290 |
| Hole Output, g/min | 7.5 | 12.6 | 7.5 | 12.6 |
| Melt temperature. ° C. | 290 | 290 | 289 | 297 |
| Air temperature, ° C. | — | — | 14.3 | 14.5 |
| Take up speed, m/min | 250 | 250 | 250 | 250 |

Properties

| | | | | |
|---|---|---|---|---|
| Titre, dtex | 281 | 465 | 295 | 503 |
| Tenacity, cN/tex | 8.7 | 6.5 | 9.2 | 6.4 |
| Elongation at break, % | >800 | >800 | >800 | >800 |
| Residual deformation, % | 14 | 14 | 14 | 11 |

The data reported in the table show the high elasticity of the fibres according to the invention that exhibit a low residual deformation after elastic recovery compared to the fibres made from propylene homopolymer.

1. Fibres comprising a thermoplastic, elastomeric polyolefin composition (I) comprising (percent by weight):
(A) 10 to less than 50% of at least one crystalline propylene polymer selected from homopolymers of propylene and random interpolymers of propylene and at least one recurring unit in amounts up to 10%, the recurring units being selected from ethylene and C₄-C₁₀ α-olefins, the said propylene polymer(s) being insoluble in xylene at room temperature in an amount higher than 80%; and
(B) over 50 to 90% of a polymer fraction comprising at least one interpolymer of ethylene and at least one α-olefin of formula H₂C═CHR₂, where R₂ is a C₁-C₈ linear or branched alkyl, said interpolymer(s) containing from 13 to less than 60% of recurring units deriving from ethylene.

2. The fibres according to claim 1 wherein the amount of (A) is from 13 to 40% and the amount of (B) is from 60 to 87%.

3. The fibres according to claim 1 wherein the polyolefin composition (I) comprises the following components (per cent by weight):
(A) 10-25% of a crystalline propylene polymer selected from propylene homopolymer having a solubility in xylene at room temperature lower than 10% and an interpolymer of propylene and at least one α-olefin of formula H₂C═CHR₂, where R₂ is hydrogen or a C₂-C₈ linear or branched alkyl, containing at least 90% of propylene, having a solubility in xylene at room temperature lower than 15%; and
(B) 75-90% of an elastomeric polymer fraction comprising:
(i) a first elastomeric interpolymer of propylene and at least one α-olefin of formula H₂C═CHR₂, where R₂ is hydrogen or a C₂-C₈ linear or branched alkyl, optionally containing 0.5 to 5% of a diene, said first elastomeric interpolymer containing from 15 to 32% of the α-olefin and having solubility in xylene at room temperature greater than 50%, the intrinsic viscosity of the xylene-soluble fraction ranging from 3.0 to 5.0 dl/g; and
(ii) a second elastomeric interpolymer of propylene and at least one α-olefin of formula H₂C═CHR₂, where R₂ is hydrogen or a C₂-C₈ linear or branched alkyl, optionally containing 0.5 to 5% of a diene, said second elastomeric interpolymer containing more than 32 up to 45% of the α-olefin and having solubility in xylene at room temperature greater than 80%, the intrinsic viscosity of the xylene-soluble fraction ranging from 4.0 to 6.5 dl/g,
wherein a weight ratio between (i) and (ii) ranges from 1:5 to 5:1.

4. The fibres according to claim 1, obtained from a thermoplastic elastomeric polyolefin composition (I) having a MFR value ranging from 0.3 to 25 g/10 min.

5. The fibres according to claim 1, obtained from a thermoplastic elastomeric polyolefin composition (I) further comprising polyethylene in amounts up to 10 wt %.

6. A process for the preparation of the fibres comprising spinning fibres in an extruder at an output per hole ranging from 5 to 15 g/min a pressure in the extruder ranging from 15 to 30 bar and a temperature in the extruder ranging from 200 to 300° C., the fibres comprising:
a thermoplastic elastomeric polyolefin composition (1) comprising (percent by weight):
(A) 10 to less than 50% of at least one crystalline propylene polymer selected from homopolymers of propylene and random interpolymers of propylene and at least one recurring unit in amounts up to 10%, the recurring units being selected from ethylene and C₄-C₁₀ α-olefins, the said propylene polymer(s) being insoluble in xylene at room temperature in an amount higher than 80%, and
(B) over 50 to 90% of a polymer fraction comprising at least one interpolymer of ethylene and at least one α-olefin of formula H₂C═CHR₂, where R₂ is a C₁-C₈ linear or branched alkyl, said interpolymer(s) containing from 13 to less than 60% of recurring units deriving from ethylene

7. The fibres according to claim 1 wherein the propylene polymers of component (A) are insoluble in xylene at room temperature in an amount higher than 90%.
